(19) United States
(12) Patent Application Publication
(10) Pub. No.: US 2014/0104234 A1
(43) Pub. Date: Apr. 17, 2014

(54) CAPACITANCE-TYPE TOUCH SENSOR

(71) Applicant: Keun Ho Chang, Daejeon (KR)

(72) Inventor: Keun Ho Chang, Daejeon (KR)

(73) Assignee: HOGAHM TECHNOLOGY CO., LTD, Daejeon (KR)

(21) Appl. No.: 14/118,180

(22) PCT Filed: Jul. 14, 2011
(86) PCT No.: PCT/KR2011/005199

§ 371 Date: Nov. 15, 2013

(30) Foreign Application Priority Data
May 17, 2011 (KR) KR10 2011-004649

(51) Int. Cl. G06F 3/044; G06F 3/041

(52) U.S. Cl. CPC G06F 3/044; G06F 3/0416
USPC 345/174

(57) ABSTRACT

A capacitive touch sensor for detecting a touch point of a user includes a transparent non-conductive base plate, a transparent electrode thin film formed on one surface of the transparent non-conductive base plate, the electrode thin film being formed such that a plurality of polygonal or circular unit cells are connected to other unit cells adjacent in horizontal and vertical directions through signal transmission conductors, and a control board in which the electrode thin film forms a first electrode of a charge capacitor and forms a second electrode of the charge capacitor when the user touches the other surface of the transparent non-conductive base plate such that the control board receives through the conductors a touch signal induced in the first electrode by a user's touch when the user touches the other surface of the transparent base plate as the second electrode and detects a touch point of the user.

### BACKGROUND OF THE INVENTION

1. Technical Field

The present invention relates to a touch sensor, and more particularly to a capacitive touch sensor locally formed with an electrostatic capacitor in which a transparent base plate such as a transparent resin film or a glass plate is constituted as a medium such that one surface of the medium is formed with one electrode, of the electrostatic capacitor, made of transparent conductive resin and an opposite surface thereof is formed with an electrode when a user's finger is touched thereon, thereby sensing such a phenomenon as an electric signal and detecting a touch position.

2. Description of Related Art

In general, a touch sensor is a device in which, when a user touches an image displayed on a screen with one's finger, a touch pen, or the like, a touch point is grasped in response to such a touch. This touch sensor is applied to, for example, a touch pad or a touch screen.

This touch sensor is typically manufactured as a structure overlaid on a flat display LCD panel or a PDP panel. The touch sensor senses a touch position of the user's finger or the touch pen to convert the touch position into a coordinate on an image screen, independently from an image displayed on the screen, and such coordinate information is transmitted to an image control device. The image control device composes the position information and the image screen received from the touch sensor and controls an image so as to perform necessary action. An actual application example of such a touch sensor includes an automated teller machine in a bank, a ticket vendor in a train station, a mobile information device, a portable telephone, and the like, and the touch sensor is in the spotlight for education.

The touch sensor is embodied by several methods, for example, methods using resistance, capacitance, surface acoustic waves, infrared light, and cameras, different from each other in terms of techniques according to the size and use of a display screen.

Among them, a capacitive touch sensor is typically manufactured by applying an ITO film on one surface or both surfaces of a thin glass plate or a transparent resin film and etching the ITO film as a specific pattern. Such an ITO film is optically transparent and restrictively has high electrical conductivity. Thus, the ITO film serves as an electrode of a capacitor and a signal transmission conductor together. Touch coordinate information of the touch sensor manufactured via the ITO film is transferred to square sides of a touch screen through the conductor formed of the ITO film. Here, the square sides are connected to a control circuit so as to transmit a touch coordinate signal to the control circuit.

However, the capacitive touch sensor manufactured via the ITO film has the following problems.

First, the ITO film constituting the touch sensor has high production costs because it is quite expensive due to rarity of indium which is a raw material thereof.

In addition, the ITO film has high manufacturing costs because of being formed by sputtering in a vacuum device. The ITO film has a complicated manufacturing process since the ITO film is formed in an electrode pattern by optical lithography and is manufactured by repeating 3 or 4 times the process, thereby being costly for manufacturing and very high price.

Besides, the ITO film serves as the transparent electrode and the signal transmission conductor and electrical resistance of the ITO film is a serious obstructive factor during high speed signal processing. Therefore, the ITO film generates serious obstacle to a multipoint touch and signal processing in an area having the size of 20 inches or more in a diagonal direction.

### SUMMARY OF THE INVENTION

Therefore, the present invention has been made in view of the above problems of the capacitive touch sensor manufactured by the conventional ITO film, and it is an object of the present invention to provide a capacitive touch sensor capable of being applied to a large touch screen or a multipoint touch by achieving simplification of a production process and low manufacturing costs and increasing signal processing speed.

In accordance with an aspect of the present invention, a capacitive touch sensor for detecting a touch point of a user includes a transparent non-conductive base plate, a transparent electrode thin film formed on one surface of the transparent non-conductive base plate, the transparent electrode thin film being formed in a net form in which a plurality of polygonal or circular unit cells are connected to each other through signal transmission conductors in horizontal, vertical, and diagonal directions, and a control board in which the transparent electrode thin film forms a first electrode of a charge capacitor and forms a second electrode of the charge capacitor when the user touches the other surface of the transparent non-conductive base plate such that the control board receives through the conductors a touch signal induced in the first electrode by a user's touch when the user touches the other surface of the transparent base plate as the second electrode and detects a touch point of the user.

Each of the unit cells of the transparent electrode thin film may be connected to other unit cells adjacent in the horizontal and vertical directions through the signal transmission conductors, and be connected to other unit cells adjacent in one diagonal direction through the signal transmission conductor, and the signal transmission conductors connecting the unit cells may be insulated and electrically isolated by transparent insulation films at intersection points of the signal transmission conductors.

The signal transmission conductors connecting the unit cells may extend up to an edge of the transparent non-conductive base plate and be connected to the control board at the edge, and the signal transmission conductors located in the vicinity of the edge of the transparent non-conductive base plate may be formed with expansion portions having a larger width than the signal transmission conductors connecting the unit cells.

In the signal transmission conductors connecting the unit cells, a coordinate of each signal transmission conductor which connects the unit cells in the vertical direction and extends up to the edge may be set to a first axis coordinate, a coordinate of each signal transmission conductor which connects the unit cells in the horizontal direction and extends up to the edge may be set to a second axis coordinate, and a coordinate of each signal transmission conductor which connects the unit cells in one diagonal direction and extends up to the edge may be set to a third axis coordinate, and the control board may combine and analyze charge signals transmitted from the signal transmission conductors set to the first, second, and third axis coordinates according to the user's touch, and may detect a touch point of the user. In addition, a coordinate of a signal transmission conductor which connects the unit cells in the other diagonal direction and extends up to the edge may be set to a fourth axis coordinate such that a charge signal generated according to the user's touch is transmitted to the control board through the conductor.

Each of the unit cells may be configured of a plurality of unit cell pads which are separated from each other, and each of the unit cell pads may be connected to any one of the signal transmission conductors defining the respective axes. Herein, in the plural unit cell pads coming into contact with the signal transmission conductors defining the respective axes, sums of areas of the unit cell pads coming into contact with the respective axes may be equally formed.

The control board may simultaneously apply pulse train signals to the signal transmission conductors defining the first axis coordinate and then sequentially detect induced charge signals generated by the user's touch in the signal transmission conductors defining the other axis coordinates, may simultaneously apply pulse train signals to the signal transmission conductors defining the second axis coordinate and then sequentially detect induced charge signals generated by the user's touch in the signal transmission conductors defining the other axis coordinates, and may detect the first and second axis coordinates according to combination of the coordinates of the induced charge signals detected through the above processes and detect a touch position of the user. In this case, the control board may produce a third axis coordinate or a fourth axis coordinate passing though the combined first and second axis coordinates, and when the produced third axis coordinate or fourth axis coordinate coincides with the detected third axis coordinate or fourth axis coordinate by comparison therewith, may grasp the associated coordinate as a actual touch position, when the produced third axis coordinate or fourth axis coordinate does not coincides with the detected third axis coordinate or fourth axis coordinate, may identify the associated coordinate as a virtual image to detect a touch position of the user.

The transparent electrode thin film may be printed and applied on one surface of the transparent non-conductive base plate.

In accordance with another aspect of the present invention, a capacitive touch sensor for detecting a touch point of a user includes a transparent non-conductive base plate, a transparent electrode thin film formed on one surface of the transparent non-conductive base plate, the transparent electrode thin film being formed such that a plurality of polygonal or circular unit cells are connected to other unit cells adjacent in horizontal and vertical directions through signal transmission conductors, and a control board in which the transparent electrode thin film forms a first electrode of a charge capacitor and forms a second electrode of the charge capacitor when the user touches the other surface of the transparent non-conductive base plate such that the control board receives through the conductors a touch signal induced in the first electrode by a user's touch when the user touches the other surface of the transparent base plate as the second electrode and detects a touch point of the user.

Each of the unit cells may be configured therein of a plurality of unit cell pads which are separated from each other, and the unit cell pads may be connected to unit cell pads formed in other unit cell adjacent thereto, thereby forming the unit cells.

Each of the unit cell pads formed in the unit cell may be connected to any one of the signal transmission conductors, and in the plural unit cell pads connected with the signal transmission conductors, sums of areas of the unit cell pads with the respective signal transmission conductors may be equally formed.

The signal transmission conductors connecting between the unit cell pads may be insulated and electrically isolated by transparent insulation films at intersection points of the signal transmission conductors.

An X-axis transparent electrode thin film formed by combination of the unit cell pads connected with the signal transmission conductors in the vertical direction and a Y-axis transparent electrode thin film formed by combination of the unit cell pads connected with the signal transmission conductors in the horizontal direction may be respectively coupled to transparent base plates, and then be coupled to each other so as to be electrically isolated through a transparent adhesive sheet, thereby forming the transparent electrode thin film.

A capacitive touch sensor according to the present invention has effects of significant simplification of a production process and a reduction in manufacturing costs by separating two functions provided by an ITO film, namely, a function as one electrode of a capacitor and a function as a signal transmission conductor, without using the expensive ITO film such that the electrode is replaced with a transparent electrode thin film made of transparent conductive resin and the signal transmission conductor is replaced with a thin metallic wire formed by a printed electronic method so as not to be identified with the naked eye. In addition, it may also be possible to recognize a multipoint touch by adopting a design capable of obtaining position information with respect to a third axis and a fourth axis.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view illustrating an example of a touch panel to which a capacitive touch sensor according to an embodiment of the present invention is installed.

FIG. 2 is a view illustrating a configuration of the capacitive touch sensor.

FIG. 3 is a side cross-sectional view of the capacitive touch sensor.

FIG. 4 is a view illustrating a configuration of each of the unit cells forming the transparent electrode thin film according to the embodiment of the present invention.

FIG. 5 is a side cross-sectional view of the unit cell.

FIGS. 6 to 9 are conceptual views illustrating an operation state of one unit cell formed on the transparent base plate according to the embodiment of the present invention.

FIG. 10 is a conceptual view illustrating coordinates when the touch point is three.

FIG. 11 is a flowchart illustrating a process grasping actual touch points indicated in FIG. 10.

FIG. 12 is a view illustrating a configuration of a capacitive touch sensor according to another embodiment of the present invention.

FIG. 13 is a view illustrating a configuration of a unit cell forming a transparent electrode thin film in FIG. 12.

FIG. 14 is a side cross-sectional view of the unit cell forming the transparent electrode thin film.

FIG. 15 is a view illustrating a configuration of a capacitive touch sensor configured of only a first axis and a second axis according to another embodiment of the present invention.

FIG. 16 is a view illustrating a configuration of a unit cell forming a transparent electrode thin film.

FIG. 17 is a view illustrating an example of a configuration in which the unit cell of the transparent electrode thin film is connected to an adjacent unit cell.

FIG. 18 is a view illustrating a configuration of a unit cell according to a further embodiment of the present invention.

FIG. 19 is a view illustrating an example in which the unit cell is formed on a transparent electrode thin film.

FIGS. 20 and 21 are views illustrating a configuration of X- and Y-axis transparent electrode thin films which are separated from each other.

FIG. 22 is a conceptual view illustrating formation of the transparent electrode thin films by coupling the X- and Y-axis transparent electrode thin films.

### DETAILED DESCRIPTION

Hereinafter, exemplary embodiments of the present invention will be described in more detail with reference to the accompanying drawings.

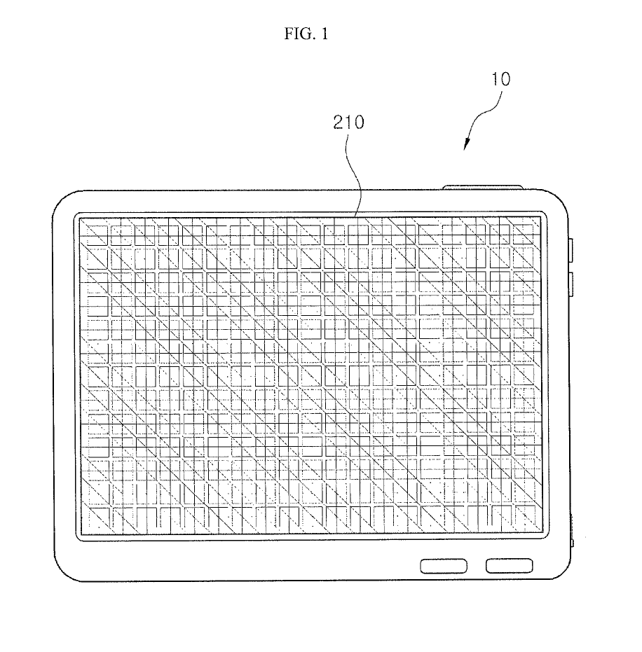

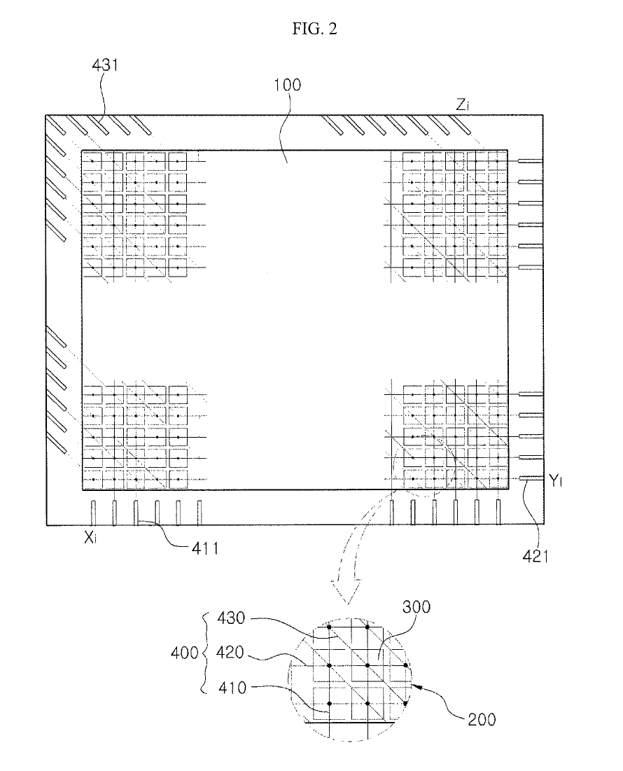

FIG. 1 is a view illustrating an example of a touch panel to which a capacitive touch sensor according to an embodiment of the present invention is installed. FIG. 2 is a view illustrating a configuration of the capacitive touch sensor. FIG. 3 is a side cross-sectional view of the capacitive touch sensor.

As shown in FIG. 1, a capacitive touch sensor according to an embodiment of the present invention is installed to a screen or a panel 10 on which an image is displayed, similarly to the conventional touch sensor. The capacitive touch sensor detects a touch position when being touched by a user and transmits the detected touch position information to an image display control device, so as to perform a command corresponding to the touch position.

As shown in FIGS. 2 and 3, the capacitive touch sensor according to the embodiment of the present invention includes a transparent non-conductive base plate 100, a transparent electrode thin film 200 formed on one surface of the transparent non-conductive base plate 100, and a control board (not shown) which, when a user touches the other surface of the transparent non-conductive base plate 100, receives a touch signal induced in the transparent electrode thin film 200 and detects a touch point of the user.

The transparent electrode thin film 200 formed on one surface of the transparent base plate 100 forms a first electrode of a charge capacitor and the other surface of the transparent base plate 100 forms a second electrode of the charge capacitor by a user's finger touching the other surface. A charge signal induced in the transparent electrode thin film 200 as the first electrode is transmitted to the control board through signal transmission conductors 400 and the control board analyses the charge signal transmitted from the transparent electrode thin film 200 as the first electrode and detects the touch point of the user.

The transparent base plate 100 is a non-conductive plate, having a rectangular shape, through which light may pass. The transparent base plate 100 may be formed of a transparent thin glass plate or various polymer resin films such as polyester. The transparent base plate 100 constitutes a body which is a base of the touch sensor, and the transparent electrode thin film 200 is applied to one surface of the transparent base plate 100 to form the first electrode.

The transparent electrode thin film 200 formed on one surface of the transparent base plate 100 is formed in a net form in which a plurality of polygonal or circular unit cells 300 are arranged in horizontal, vertical, and diagonal directions. Each of the unit cells 300 is connected to other unit cells 300 adjacent in the horizontal and vertical directions through respective signal transmission conductors 410 and 420, and is connected to other unit cells 300 adjacent in one diagonal direction through a signal transmission conductor 430. Intersection points of the horizontal, vertical, and diagonal signal transmission conductors 400 (410, 420, and 430) connecting the unit cells 300 occur in central points of the unit cells 300, respectively. In the embodiment of the present invention, the intersection points are electrically isolated by respective transparent insulation films 500 such that short circuits are not generated at the intersection points.

The signal transmission conductors 400 connecting the unit cells 300 extend up to an edge of the transparent non-conductive base plate 100 and are connected to the control board at the edge. The signal transmission conductors 400 (410, 420, and 430) located adjacent in the vicinity of the edge of the transparent non-conductive base plate 100 are formed with expansion portions 411, 412, and 413 having a larger width than the signal transmission conductors connecting the unit cells 300, thereby facilitating connection of the conductors and the control board.

In the embodiment of the present invention, the signal transmission conductors 400 connecting the unit cells 300 define coordinate axes of the respective unit cells 300. For example, the coordinate of each signal transmission conductor 410 which connects the unit cells 300 in the vertical direction and extends up to the edge is set to an X-axis coordinate as a first axis coordinate, the coordinate of each signal transmission conductor 420 which connects the unit cells 300 in the horizontal direction and extends up to the edge is set to a Y-axis coordinate as a second axis coordinate, and the coordinate of each signal transmission conductor 430 which connects the unit cells 300 in one diagonal direction and extends up to the edge is set to a Z-axis coordinate as a third axis coordinate. A process of grasping the touch point of the user through the unit cells 300 connected by the signal transmission conductors 400 (410, 420, and 430) is performed by equally applying pulse train signals to all of the X-axis signal transmission conductors 410 and then sequentially touching the respective Y-axis and Z-axis signal transmission conductors 420 and 430 one by one by a user to detect touch position signals generated thereby. Next, in the same manner, pulse train signals are applied to the Y-axis signal transmission conductors 420, and then touch position signals are detected by sequentially touching the respective X-axis and Z-axis signal transmission conductors 410 and 430 one by one. Touch position coordinates are obtained by combination of X- and Y-axis position signals among X-, Y-, and Z-axis position signals obtained through the above processes. Here, the coordinate of each unit cell 300 may be grasped if the X and Y coordinates are obtained. In this case, the Z-axis coordinate is used to remove a virtual signal caused when two or more touches are generated. If virtual identification is difficult by the Z-axis coordinate alone due to touches of many users, it may also be possible to reinforce a virtual signal removal function by further adding one signal transmission conductor defining a separate W-axis.

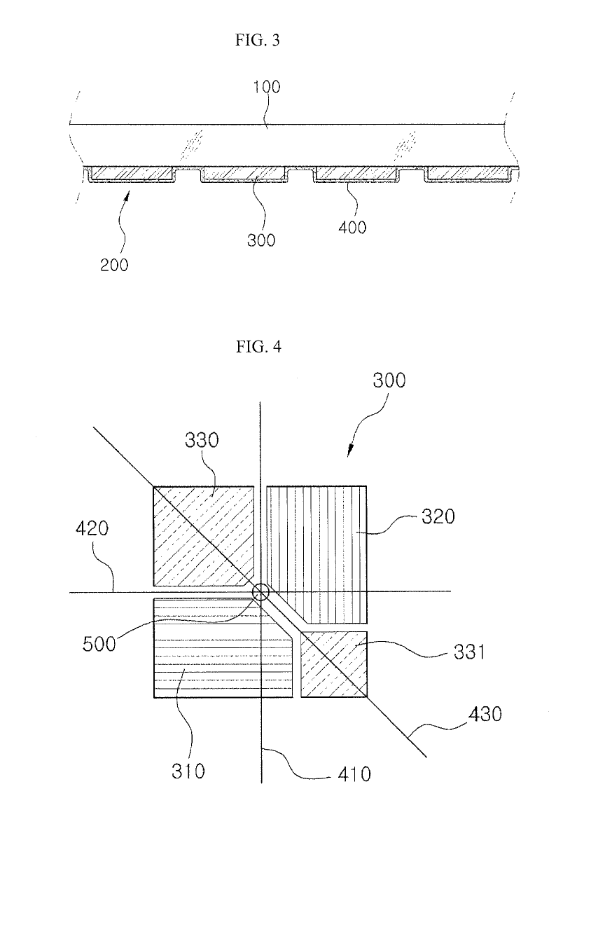

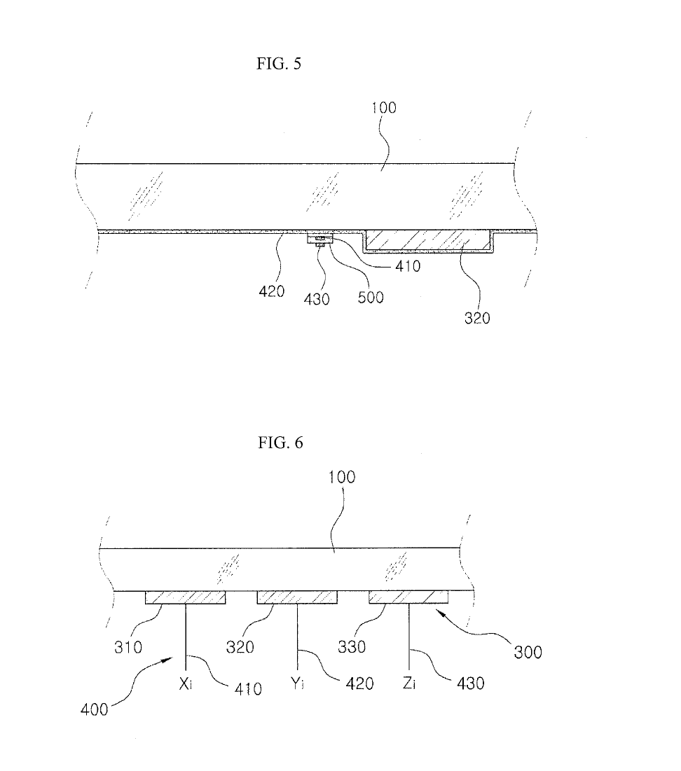

FIG. 4 is a view illustrating a configuration of each of the unit cells forming the transparent electrode thin film according to the embodiment of the present invention. FIG. 5 is a side cross-sectional view of the unit cell.

As shown in FIGS. 4 and 5, each unit cell 300 of the transparent electrode thin film 200 is configured of a plurality of unit cell pads 310, 320, 330, and 331 which are separated from each other in a polygonal shape. Each of the plural unit cell pads 310, 320, 330, and 331 is connected to any one of the respective X-, Y-, and Z-axis signal transmission conductors 400.

The three signal transmission conductors 400 meet at the central point of the unit cell 300. The transparent insulation films 500 are formed such that the three signal transmission conductors 400 are insulated from each other at the central point of the unit cell 300 at which the signal transmission conductors 400 overlap. That is, the transparent insulation films 500 are respectively applied between the X- and Y-axis signal transmission conductors 410 and 420 and between the Y- and Z-axis signal transmission conductors 420 and 430 such that the three conductors may be electrically isolated from each other.

The unit cell 300 shown in FIGS. 4 and 5 is formed of four unit cell pads in total. Among them, one unit cell pad 310 is connected to the X-axis conductor 410, another unit cell pad 320 is connected to the Y-axis conductor 420, and the other two unit cell pads 330 and 331 are connected to the Z-axis conductor 430. In the plural unit cell pads 310, 320, 330, and 331 coming into contact with the signal transmission conductors 400 (410, 420, and 430) defining the respective axes, areas of the unit cell pads coming into contact with the respective axes are equally formed. That is, the area of the unit cell pad 310 connected to the X-axis conductor 410, the area of the unit cell pad 320 connected to the Y-axis conductor 420, and the sum of the areas of the unit cell pads 330 and 331 connected to the Z-axis conductor 430 are equal to each other. According to such a same area distribution principle, the shape of the unit cell pad shown in FIG. 4 may also be formed in another shape. That is, if the unit cell pads 310, 320, 330, and 331 may satisfy the same area distribution principle, the number and shape of each pad may be properly changed. For example, the pad may have a circular shape instead of a polygonal shape. In addition, the unit cell 300 configured of the unit cell pads 310, 320, 330, and 331 may have a circular shape or the like instead of a polygonal shape if the unit cell pads may satisfy the same area distribution principle.

The signal transmission conductors 400 (410, 420, and 430) connecting the unit cell pads 310, 320, 330, and 331 serve to transfer the touch signals generated by the unit cell pads to the external control board. The signal transmission conductors 400 (410, 420, and 430) are not produced in a transparent form. Accordingly, when each of the signal transmission conductors has a thick width, there is a problem in that the signal transmission conductor is visible by a user' eyes to cover the screen (pad) disposed below thereof Thus, each of signal transmission conductors 400 (410, 420, and 430) is preferably formed in a very thin form using very high conductivity so as not to be visible by a user' eyes without using a magnifying glass. In the embodiment of the present invention, each of signal transmission conductors 400 (410, 420, and 430) is formed to have a width of 20 μm or less, thereby obtaining transparency so as not to be identified by a user's naked eye.

The unit cells 300 configured of the combination of the plural unit cell pads 310, 320, 330, and 331 are thinly applied and arranged on one surface of the transparent base plate 100. The unit cells 300 have transparency and conductivity and are formed via a simply printed method in the atmosphere instead of a difficult process such as vacuum deposition. In the embodiment of the present invention, each of the unit cells 300 is printed and applied on one surface of the transparent base plate 100 by a printed method such as a silk screen method. The unit cell 300 is made of a material such as a polymeric material (for example, PEDOT/PSS) having transparency and conductivity.

Hereinafter, a description will be given of operation grasping a touch position of a user through the capacitive touch sensor having the above configurations.

FIGS. 6 to 9 are conceptual views illustrating an operation state of one unit cell formed on the transparent base plate according to the embodiment of the present invention.

FIG. 6 shows the arrangement of the unit cell pads forming one unit cell 300 formed on the transparent base plate 100. FIG. 6 shows that the plural unit cell pads 310, 320, 330, and 331 connected to the X-, Y-, and Z-axis conductors 410, 420, and 430 are arranged on the transparent base plate 100 by forming one electrode of a capacitor on the transparent base plate 100 as a medium. Since the capacitor may function in a state in which a counter electrode is essentially formed on an opposite surface of the transparent base plate 100, the capacitor may not function in a structure as shown in FIG. 6.

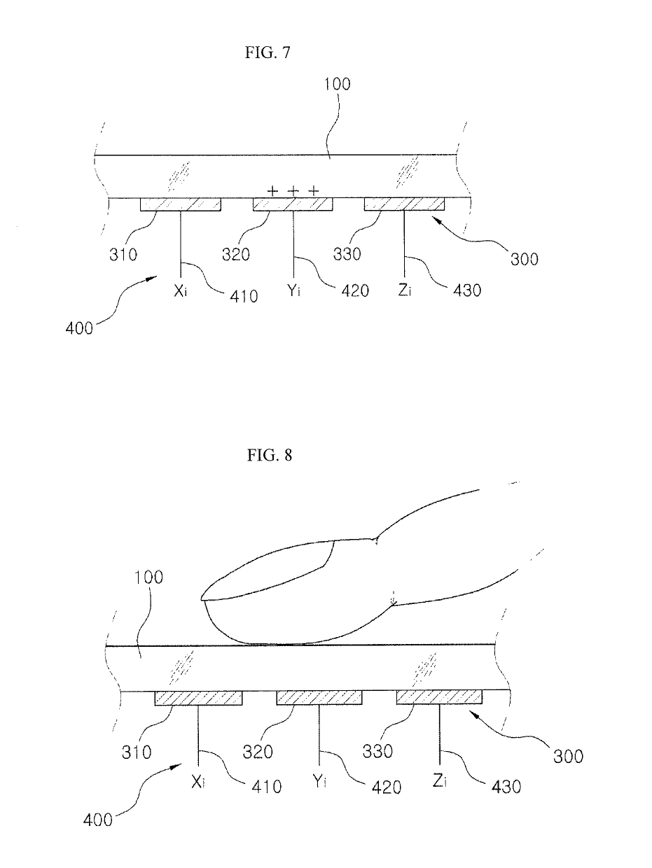

FIG. 7 is a conceptual view illustrating a state of being not operated as the capacitor. In FIG. 7, even in a case of applying a charge pulse to the Y-axis unit cell pad 320 through the Y-axis conductor 420, since a counter electrode is not formed on the other surface of the transparent base plate 100, the capacitor does not react with respect to the periphery thereof.

Meanwhile, FIG. 8 is a conceptual view illustrating a state in which a user's finger is touched on the other surface of the transparent base plate 100 formed, at one surface thereof, with the unit cell pads. FIG. 9 is a conceptual view illustrating an equivalent circuit of FIG. 8. As shown in FIGS. 8 and 9, when a user's finger is touched on the other surface of the transparent base plate 100, the other surface of the transparent base plate 100 serves as an opposite electrode of the unit cell pads. This is because a user's body serves as a ground wire (ground) 350 due to having large charge capacitance. Accordingly, mutual capacitance is generated between these electrodes. In this case, when a charge (+) pulse is applied to any one of the unit cell pads, for example, the Y-axis unit cell pad 320, a reverse polar charge (−) is induced in the ground wire 350 made by the finger so that reverse charges (+) of the ground wire 350 are induced in the X- and Z-axis unit cell pads 310 and 330. Through such a process, the touch position signals of the finger are produced on the X- and Z-axis unit cell pads 310 and 330. Next, when a charge (+) pulse is applied to the X-axis unit cell pad 310, charge signals are produced in the Y- and Z-axis unit cell pads 320 and 330 in the above same principle. By a method of applying the charge pulses one by one to the X- and Y-axes, it may be possible to obtain a touch point of the Z-axis, more accurately a coordinate signal of the touched unit cell 300. As such, the control board applies the charge pulses to the unit cells 300 and then detects the charge signal generated by each unit cell 300, thereby grasping the touch point of the user.

As described above, in a case in which only one touch point is present, the touch point may be grasped when the X- and Y-axis coordinate positions of the touched unit cell 300 are sensed. However, when two or more touch points are present, a virtual point may be generated. For example, when two coordinates of x1 and x2 on the X-axis and two coordinates of y1 and y2 on the Y-axis are sensed, four points obtained by (x1, y1), (x1, y2), (x2, y1), and (x2, y2) which are combination of the coordinates are produced. Among them, the two points are actual touch points and the remaining two points are virtual points. This is because the coordinate of one point is not identified as a set of x and y coordinates such as (x1, y1) and (x2, y2). In other words, since the X-axis coordinate and the Y-axis coordinate are sequentially identified and are then produced through signal processing, a set of coordinates is not obtained. When the touch point is three, nine points obtained by combination of x1, x2, x3 coordinates and y1, y2, y3 coordinates are produced. The number of the coordinate combinations is typically defined by the square of the number of the touch points. Among these points, the actual touch point and the virtual point have to be identified. However, since identification of the actual touch point and the virtual point using only information of the X- and Y-axis coordinates is logically impossible, the present invention produces a third coordinate, namely, Z-axis information and utilizes the same, thereby allowing the actual touch point and the virtual point to be identified.

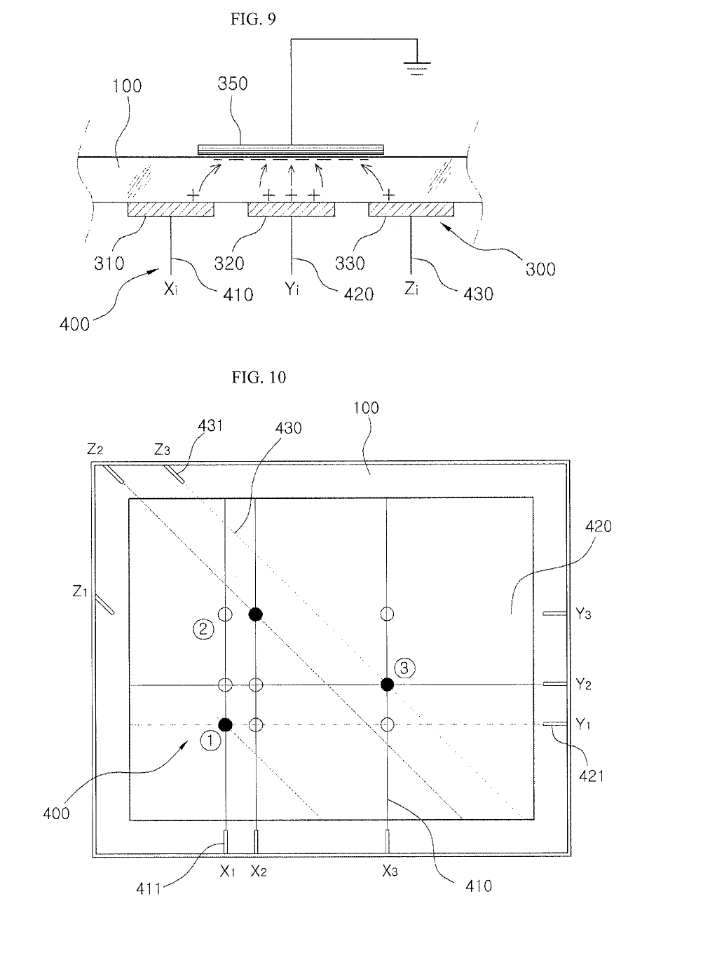

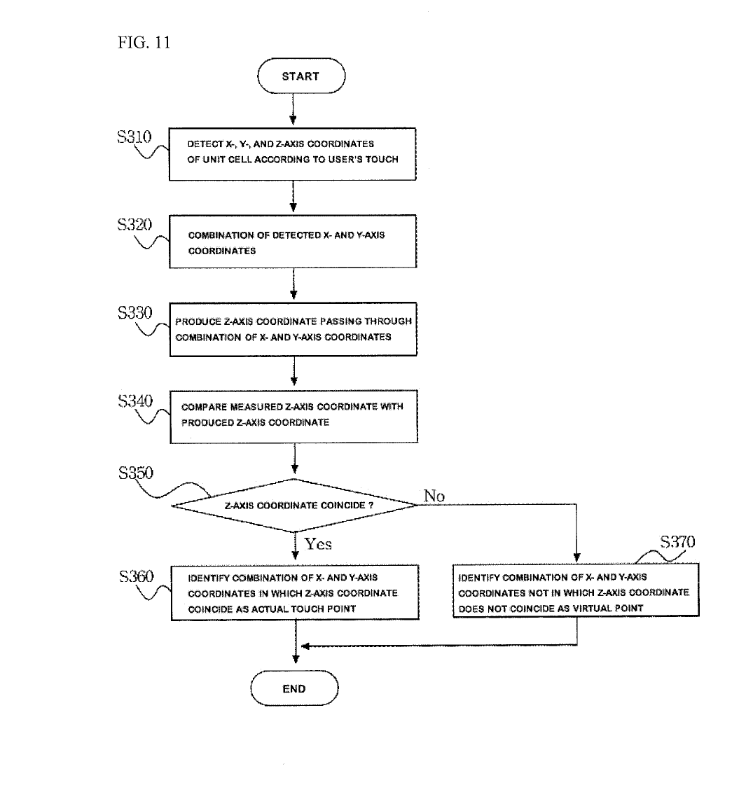

FIG. 10 is a conceptual view illustrating coordinates when the touch point is three. FIG. 11 is a flowchart illustrating a process grasping actual touch points indicated in FIG. 10.

As shown in FIG. 10, when the actual touch point of a user is three points such as (x1, y1), (x2, y3), and (x3, y2), associated six virtual points such as (x1, y2), (x1, y3), (x2, y1), (x2, y2), (x3, y1), and (x3, y3) are produced. A method of identifying these actual points and virtual points is performed via a process of FIG. 11.

Steps S310 and S320: first, as illustrated in FIGS. 6 to 9, the X-, Y-, and Z-axis coordinates of the unit cell 300 generated according to the user's touch are detected (S310) and produces a set of coordinates capable of being generated by combination of the detected X- and Y-axis coordinates. As shown in FIG. 6, when the actual touch point is three, nine sets of coordinates in total are created.

Step S330: after a set of X- and Y-axis coordinates capable of being generated via the above process is created, a Z-axis coordinate passing through the created set of X- and Y-axis coordinates is produced. The Z-axis coordinate passing through the set of X- and Y-axis coordinates may be calculated according to the relation of the predetermined X-, Y-, and Z-axes.

Step S340: the Z-axis coordinates measured in step S310 are searched and are then compared with the Z-axis coordinate produced in step S330.

Steps S350, S360, and S370: if a Z-axis coordinate of a case in which the Z-axis coordinate produced from the set of X- and Y-axis coordinates coincides with the measured Z-axis coordinate is present (S350), the set of X- and Y-axis coordinates is identified as an actual touch point (S360). If a Z-axis coordinate of a case in which the Z-axis coordinate produced from the set of X- and Y-axis coordinates coincides with the measured Z-axis coordinate is not present, the set of X- and Y-axis coordinates is identified as a virtual point (S370). FIG. 6 shows the X- and Y-axis coordinates together with the Z-axis coordinate and shows that the Z-axis signals are generated in the actual touch points but are not generated in the virtual points. Accordingly, it may be possible to identify the three actual touch points from the nine combinations of the X- and Y-axis coordinates by reading the Z-axis signals.

As described above, it may be possible to recognize and grasp the plural touch points of the user by means of using the Z-axis coordinate together with the X- and Y-axis coordinates. However, if the number of the touch points is increased, an identification process is further complicated and various problems may be caused in that the plural points have the same Z-axis coordinate.

In a case in which the touch point may not be grasped only using the X- and Y-axis coordinates, it may be possible to further increase identification performance in a complicated case by adding a separate W-axis as an inclined axis to the X-, Y-, and Z-axes.

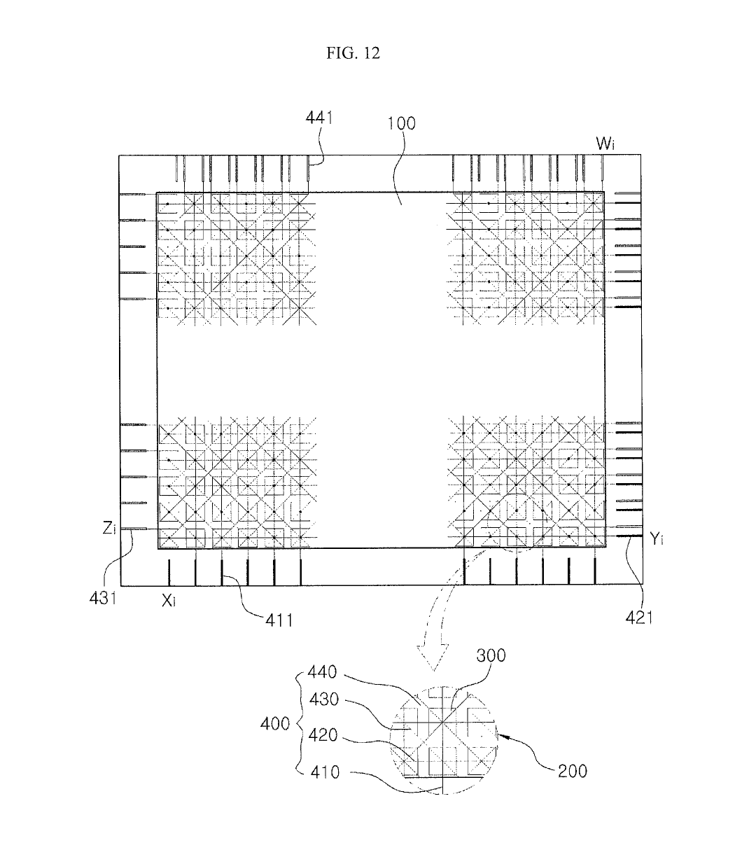

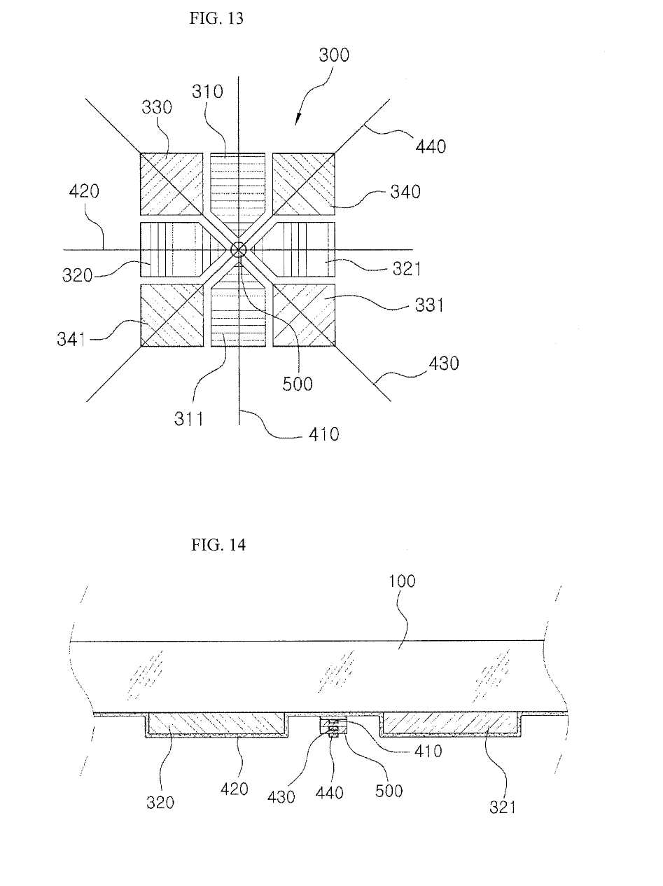

FIG. 12 is a view illustrating a configuration of a capacitive touch sensor according to another embodiment of the present invention. FIG. 13 is a view illustrating a configuration of a unit cell forming a transparent electrode thin film in FIG. 12. FIG. 14 is a side cross-sectional view of the unit cell forming the transparent electrode thin film.

As shown in FIG. 12, in another embodiment of the present invention, the signal transmission conductors 400 connecting the unit cells 300 further include a W-axis conductor 440 as a fourth axis in the other diagonal direction, in addition to the X-axis conductor 410 as the first axis in the vertical direction, the Y-axis conductor 420 as the second axis in the horizontal direction, and the Z-axis conductor 430 as the third axis in one diagonal direction. The W-axis conductor 440 added in FIG. 12 extends up to the edge and is connected to the control board at the edge, similarly to the other X-, Y-, and Z-axis conductors 410, 420, and 430. Expansion portions 411, 421, 431, and 441 having a larger width are formed in the vicinity of the edges of the X-, Y-, Z-, and W-axis signal transmission conductors 400 (410, 420, 430, and 440), thereby facilitating connection with the control board.

Similarly to being illustrated in FIGS. 2 to 11, a process of grasping the touch point of the user through the unit cells 300 connected through the X-, Y-, Z-, and W-axis signal transmission conductors 400 (410, 420, 430, and 440) is performed by equally applying pulse train signals to all of the X-axis signal transmission conductors 410 and then sequentially touching the respective Y-, Z-, and W-axis signal transmission conductors 420, 430, and 440 one by one by a user to detect touch position signals generated thereby. Next, in the same manner, pulse train signals are applied to the Y-axis signal transmission conductors 420, and then touch position signals are detected by sequentially touching the respective X-, Z-, and W-axis signal transmission conductors 410, 430, and 440 one by one. Thus, touch positions are obtained by combination of the detected X-, Y-, Z-, and W-axis position signals. Here, the Z- and W-axis coordinates are used to remove virtual signals caused when a plurality of touches are simultaneously generated.

Meanwhile, as shown in FIGS. 13 and 14, the unit cell 300 of the transparent electrode thin film 200 is configured of a plurality of unit cell pads (310, 311), (320, 321), (330, 331), and (340, 341) which are separated from each other in a polygonal shape. Each of the plural unit cell pads 310, 320, 330, and 331 is connected to any one of the respective X-, Y-, Z-, and W-axis signal transmission conductors 400. In addition, transparent insulation films 500 are formed at the central points of the unit cell 300 at which the four signal transmission conductors 400 defining the respective X-, Y-, Z-, and W-axes meet such that the four signal transmission conductors 400 are insulated from each other.

The unit cell 300 shown in FIGS. 13 and 14 is formed of eight unit cell pads 310, 311, 320, 321, 330, 331, 340, and 341 in total. Sets of two unit cell pads (310, 311), (320, 321), (330, 331), and (340, 341) which are symmetrical on the basis of the central point of the unit cell 300 are respectively connected to the X-axis conductor 410, the Y-axis conductor 420, the Z-axis conductor 430, and the W-axis conductor 440. As such, in the plural unit cell pads coming into contact with the signal transmission conductors 400 defining the respective axes, areas of the unit cell pads coming into contact with the respective axes are equally formed. That is, the sum of the areas of the unit cell pads 310 and 311 connected to the X-axis conductor 410, the sum of the areas of the unit cell pads 320 and 321 connected to the Y-axis conductor 420, the sum of the areas of the unit cell pads 330 and 331 connected to the Z-axis conductor 430, and the sum of the areas of the unit cell pads 340 and 341 connected to the W-axis conductor 440 are equal to each other according to the same area distribution principle.

In the present embodiment, a virtual touch point may be removed by adding the Z- and W-axes to the X- and Y-axes in order to identify multiple touch points of the user. Meanwhile, when the touch pad to which the touch sensor is applied has a relative small size and requires only a simply function, the touch point of the user may be detected using the X- and Y-axes alone without addition of the separate Z- and W-axes.

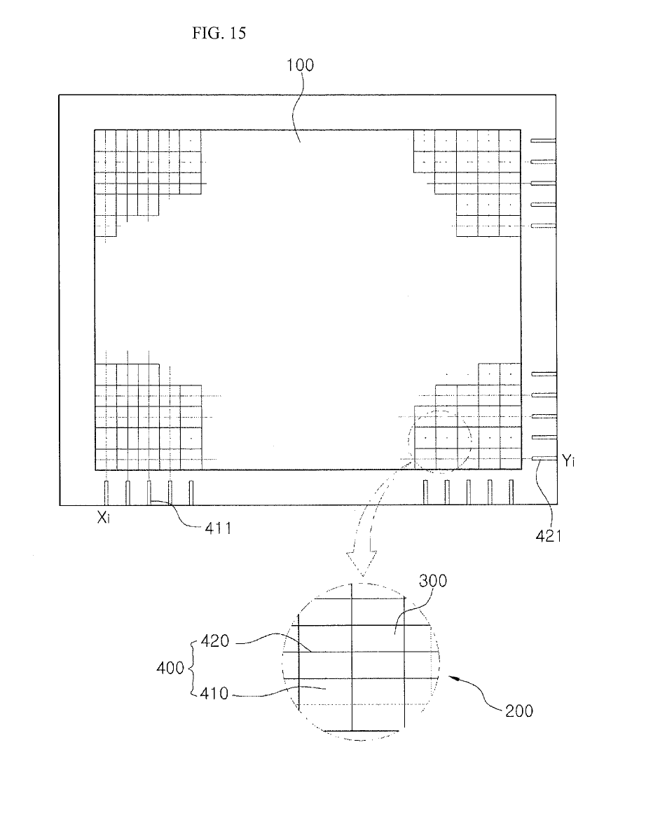

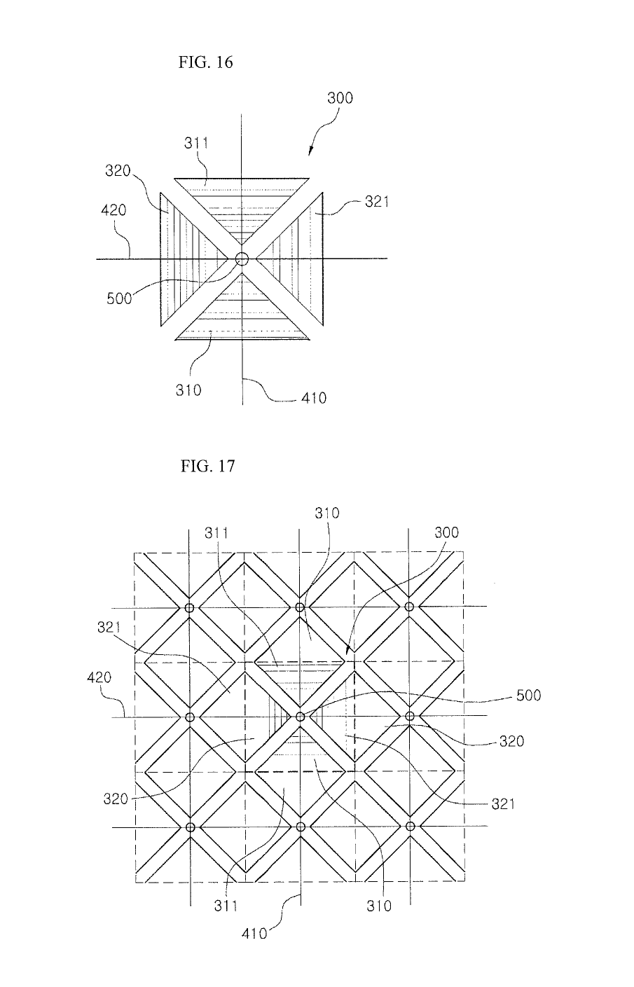

FIG. 15 is a view illustrating a configuration of a capacitive touch sensor configured of only a first axis and a second axis according to another embodiment of the present invention. FIG. 16 is a view illustrating a configuration of a unit cell forming a transparent electrode thin film. FIG. 17 is a view illustrating an example of a configuration in which the unit cell of the transparent electrode thin film is connected to an adjacent unit cell.

As shown in FIGS. 15 to 17, in the touch sensor according to another embodiment of the present invention, the transparent electrode thin film 200 is formed by separating the unit cells 300 and the signal transmission conductors 400 without using the ITO film, and the touch point of the user may be detected using only the X- and Y-axes.

In the touch sensor, the transparent electrode thin film 200 is formed by arrangement of the plural unit cells 300. The plural unit cells 300 is continuously connected adjacent to each other in the vertical and horizontal directions without being spaced apart from each other, thereby forming the transparent electrode thin film 200. In addition, the signal transmission conductors 400 electrically connecting the unit cells 300 are formed with only the X-axis conductor 410 as the first axis and the Y-axis conductor 420 as the second axis, and the Z- and W-axis conductors in the diagonal direction, which are present in the embodiments of FIGS. 1 to 14, are not present in the signal transmission conductors 400.

As shown in FIG. 16, each unit cell 300 is formed of four unit cell pads 310, 311, 320, and 321 in total. Sets of two unit cell pads (310, 311) and (320, 321) which are symmetrical on the basis of the central point of the unit cell 300 are respectively connected to the X-axis conductor 410 and the Y-axis conductor 420. As such, in the plural unit cell pads (310, 311) and (320, 321) coming into contact with the signal transmission conductors 410 and 420 defining the respective axes, areas of the unit cell pads (310, 311) and (320, 321) coming into contact with the respective axes are equally formed. That is, the sum of the areas of the unit cell pads 310 and 311 connected to the X-axis conductor 410 and the sum of the areas of the unit cell pads 320 and 321 connected to the Y-axis conductor 420 are equal to each other according to the same area distribution principle. In addition, transparent insulation films 500 are formed at the central points of the unit cell 300 at which the two signal transmission conductors 410 and 420 defining the respective axes meet such that the two signal transmission conductors 410 and 420 are insulated from each other.

As shown in FIG. 17, the adjacent unit cells 300 have a mutually connected form instead of the mutually spaced form as shown in FIGS. 1 to 14. That is, the unit cell pads constituting one unit cell 300 are connected to the unit cell pads of the adjacent unit cell 300 and the unit cells 300 are connected so as to be entirely adjacent to each other, thereby forming the transparent electrode thin film 200.

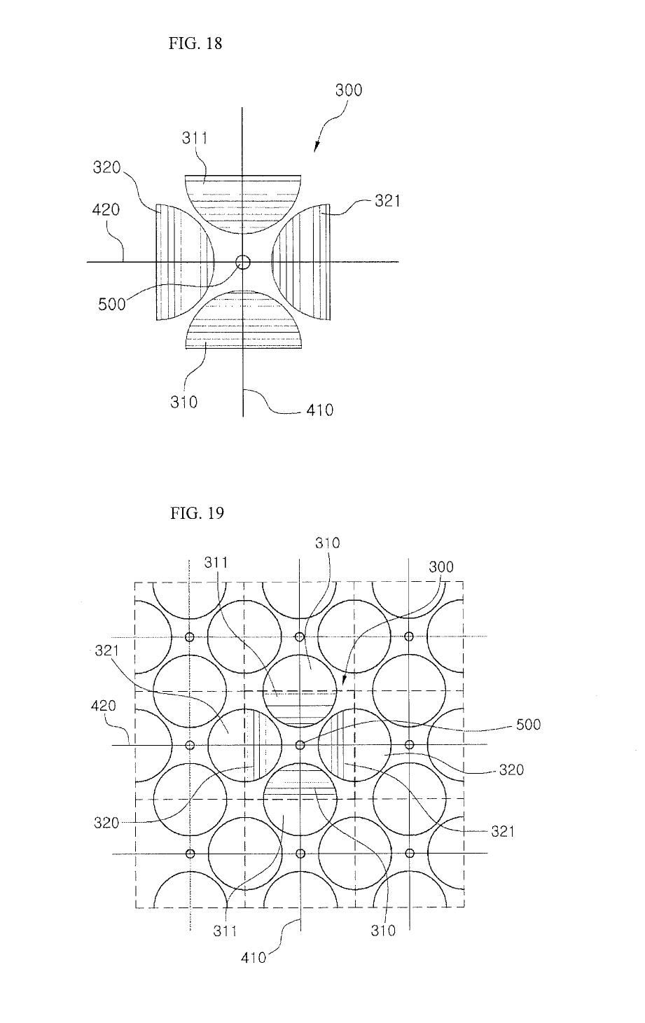

Meanwhile, although the unit cells 300 and the unit cell pads 310, 311, 320, and 321 have been described to be formed in a polygonal shape in FIGS. 15 to 17, the unit cells 300 and the unit cell pads 310, 311, 320, and 321 may be changed in various shapes. FIG. 18 is a view illustrating a configuration of a unit cell according to a further embodiment of the present invention. FIG. 19 is a view illustrating an example in which the unit cell is formed on a transparent electrode thin film.

As shown in FIGS. 18 and 19, each of unit cell pads 310, 311, 320, and 321 forming the unit cell 300 is formed in a semicircular shape. The unit cell pads 310, 311, 320, and 321 of the unit cell 300 are directly connected to unit cell pads of another unit cell, thereby forming the transparent electrode thin film 200. The unit cell pads 310 and the unit cell pads 310, 311, 320, and 321 may be changed in various shapes, in addition to the above-mentioned polygonal, circular, and semicircular shapes.

Although the transparent electrode thin films formed of two X- and Y-axes shown in FIGS. 15 to 19 may be integrally formed, the X- and Y-axis transparent electrode thin films may be manufactured, after being separately manufactured, through coupling thereof.

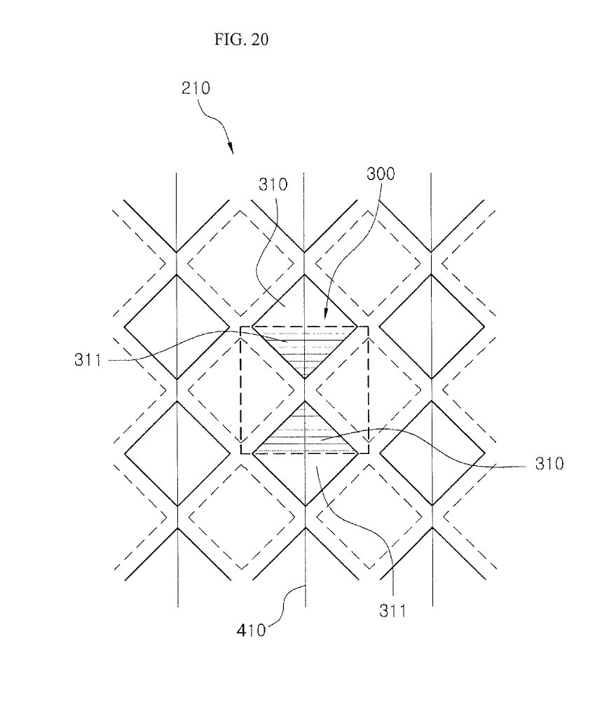

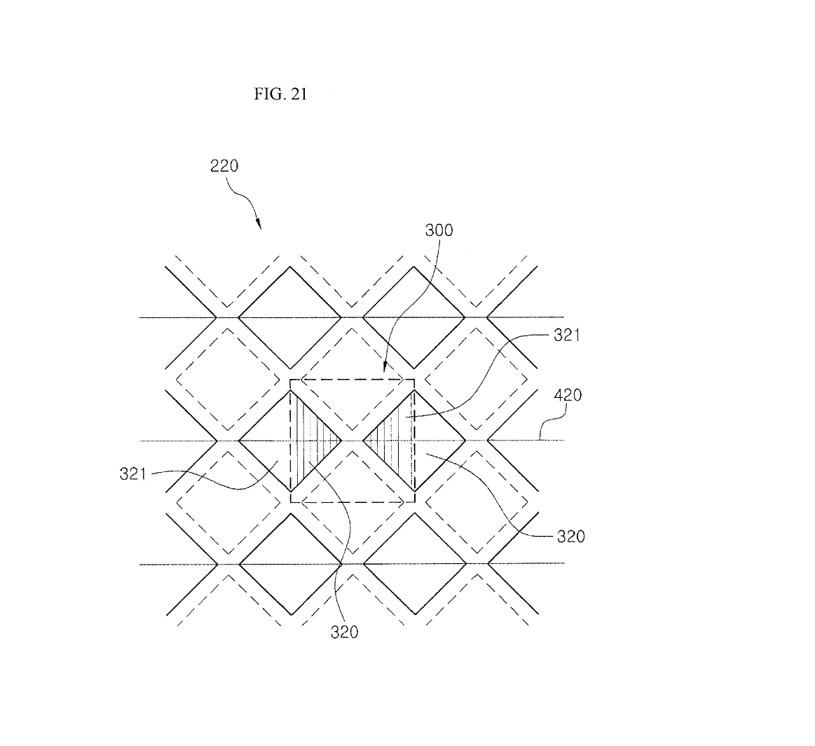

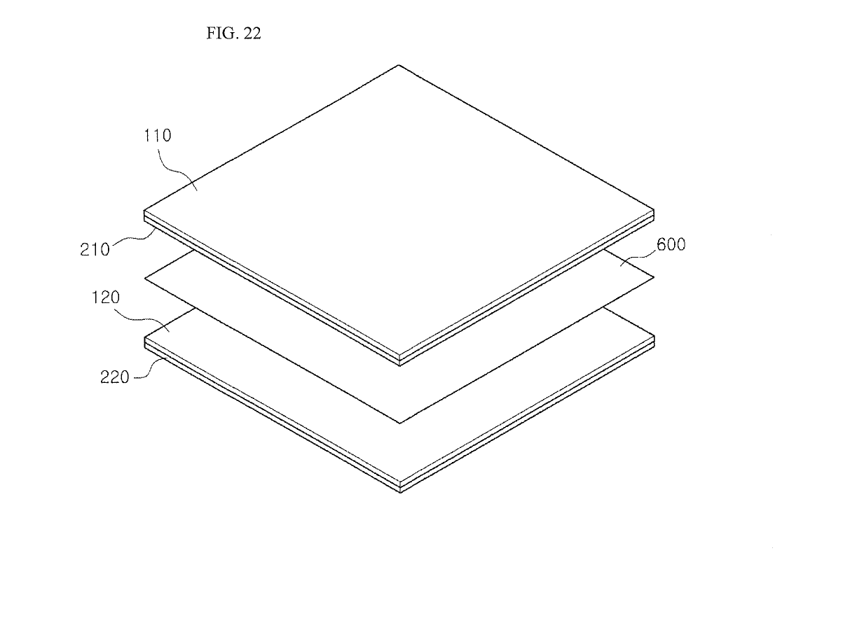

FIGS. 20 and 21 are views illustrating a configuration of X- and Y-axis transparent electrode thin films which are separated from each other. FIG. 22 is a conceptual view illustrating formation of the transparent electrode thin films by coupling the X- and Y-axis transparent electrode thin films.

As shown in FIG. 20, the plural unit cells are connected through an X-axis signal transmission conductor 410 to form a transparent electrode thin film 210. As shown in FIG. 21, the plural unit cells are connected through a Y-axis signal transmission conductor 420 to separately form a transparent electrode thin film 220.

As shown in FIG. 22, each of the X- and Y-axis transparent electrode thin films 210 and 220 which are separately configured is connected to one side of each of transparent base plates 110 and 120. Thus, the X- and Y-axis transparent base plates 110 and 120 are formed. The X- and Y-axis transparent base plates 110 and 120 which are formed as described above are coupled to each other through a transparent adhesive sheet 600, thereby manufacturing the transparent electrode thin films formed with the X- and Y-axis unit cells.

In a case of forming the transparent electrode thin films on the transparent base plates by a method in FIGS. 20 to 22, since the X-axis conductor and the Y-axis conductor are separated by the transparent adhesive sheet 600, a separate transparent insulation film may not be configured.

In the capacitive touch sensor according to the present invention which may be changed in various shapes, the transparent electrode thin film 200 on which the plural unit cells 30 are arranged is formed on one surface of the transparent non-conductive base plate 100. When the user touches the other surface of the transparent base plate 100, the touch sensor may detect the signals generated from the unit cells 300 by mutual capacitance and grasp the touch position.

Various embodiments have been described in the best mode for carrying out the invention. Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A capacitive touch sensor for detecting a touch point of a user, comprising:
a transparent non-conductive base plate;
a transparent electrode thin film formed on one surface of the transparent non-conductive base plate, the transparent electrode thin film being formed in a net form in which a plurality of polygonal or circular unit cells are connected to each other through signal transmission conductors in horizontal, vertical, and diagonal directions; and
a control board in which the transparent electrode thin film forms a first electrode of a charge capacitor and forms a second electrode of the charge capacitor when the user touches the other surface of the transparent non-conductive base plate such that the control board receives through the conductors a touch signal induced in the first electrode by a user's touch when the user touches the other surface of the transparent base plate as the second electrode and detects a touch point of the user.

2. The capacitive touch sensor according to claim 1, wherein:
each of the unit cells of the transparent electrode thin film is connected to other unit cells adjacent in the horizontal and vertical directions through the signal transmission conductors, and is connected to other unit cells adjacent in one diagonal direction through the signal transmission conductor; and
the signal transmission conductors connecting the unit cells are insulated and electrically isolated by transparent insulation films at intersection points of the signal transmission conductors.

3. The capacitive touch sensor according to claim 2, wherein:
the signal transmission conductors connecting the unit cells extend up to an edge of the transparent non-conductive base plate and are connected to the control board at the edge; and
the signal transmission conductors located in the vicinity of the edge of the transparent non-conductive base plate are formed with expansion portions having a larger width than the signal transmission conductors connecting the unit cells.

4. The capacitive touch sensor according to claim 3, wherein:
in the signal transmission conductors connecting the unit cells, a coordinate of each signal transmission conductor which connects the unit cells in the vertical direction and extends up to the edge is set to a first axis coordinate, a coordinate of each signal transmission conductor which connects the unit cells in the horizontal direction and extends up to the edge is set to a second axis coordinate, and a coordinate of each signal transmission conductor which connects the unit cells in one diagonal direction and extends up to the edge is set to a third axis coordinate; and
the control board combines and analyses charge signals transmitted from the signal transmission conductors set to the first, second, and third axis coordinates according to the user's touch, and detects a touch point of the user.

5. The capacitive touch sensor according to claim 4, wherein a coordinate of a signal transmission conductor which connects the unit cells in the other diagonal direction and extends up to the edge is set to a fourth axis coordinate such that a charge signal generated according to the user's touch is transmitted to the control board through the conductor.

6. The capacitive touch sensor according to claim 4, wherein each of the unit cells is configured of a plurality of unit cell pads which are separated from each other, and each of the unit cell pads is connected to any one of the signal transmission conductors defining the respective axes.

7. The capacitive touch sensor according to claim 6, wherein, in the plural unit cell pads coming into contact with the signal transmission conductors defining the respective axes, sums of areas of the unit cell pads coming into contact with the respective axes are equally formed.

8. The capacitive touch sensor according to claim 4, wherein the control board, simultaneously applies pulse train signals to the signal transmission conductors defining the first axis coordinate and then sequentially detects induced charge signals generated by the user's touch in the signal transmission conductors defining the other axis coordinates,
simultaneously applies pulse train signals to the signal transmission conductors defining the second axis coordinate and then sequentially detects induced charge signals generated by the user's touch in the signal transmission conductors defining the other axis coordinates, and
detects the first and second axis coordinates according to combination of the coordinates of the induced charge signals detected through the above processes and detects a touch position of the user.

9. The capacitive touch sensor according to claim 8, wherein the control board,
produces a third axis coordinate or a fourth axis coordinate passing though the combined first and second axis coordinates, and
when the produced third axis coordinate or fourth axis coordinate coincides with the detected third axis coordinate or fourth axis coordinate by comparison therewith, grasps the associated coordinate as an actual touch position, when the produced third axis coordinate or fourth axis coordinate does not coincide with the detected third axis coordinate or fourth axis coordinate, identifies the associated coordinate as a virtual image to detect a touch position of the user.

10. The capacitive touch sensor according to claim 1, wherein the transparent electrode thin film is printed and applied on one surface of the transparent non-conductive base plate.

11. A capacitive touch sensor for detecting a touch point of a user, comprising:
a transparent non-conductive base plate;
a transparent electrode thin film formed on one surface of the transparent non-conductive base plate, the transparent electrode thin film being formed such that a plurality of polygonal or circular unit cells are connected to other unit cells adjacent in horizontal and vertical directions through signal transmission conductors; and
a control board in which the transparent electrode thin film forms a first electrode of a charge capacitor and forms a second electrode of the charge capacitor when the user touches the other surface of the transparent non-conductive base plate such that the control board receives through the conductors a touch signal induced in the first electrode by a user's touch when the user touches the other surface of the transparent base plate 0-0-0) as the second electrode and detects a touch point of the user.

12. The capacitive touch sensor according to claim 11, wherein:
each of the unit cells is configured therein of a plurality of unit cell pads which are separated from each other; and
the unit cell pads are connected to unit cell pads formed in other unit cell adjacent thereto, thereby forming the unit cells.

13. The capacitive touch sensor according to claim 12, wherein:
each of the unit cell pads formed in the unit cell is connected to any one of the signal transmission conductors; and
in the plural unit cell pads connected with the signal transmission conductors, sums of areas of the unit cell pads with the respective signal transmission conductors are equally formed.

14. The capacitive touch sensor according to claim 12, wherein the signal transmission conductors connecting between the unit cell pads are insulated and electrically isolated by transparent insulation films at intersection points of the signal transmission conductors.

15. The capacitive touch sensor according to claim 12, wherein an X-axis transparent electrode thin film formed by combination of the unit cell pads connected with the signal transmission conductors in the vertical direction and a Y-axis transparent electrode thin film formed by combination of the unit cell pads connected with the signal transmission conductors in the horizontal direction are respectively coupled to transparent base plates, and are then coupled to each other so as to be electrically isolated through a transparent adhesive sheet, thereby forming the transparent electrode thin film.
